(19) United States
(12) Patent Application Publication
(10) Pub. No.: US 2013/0311762 A1
(43) Pub. Date: Nov. 21, 2013

(54) PROVIDING USER ACCESS TO SPECIFIC PROGRAMS AND DOCUMENTS BEFORE THE BOOTING PROCESS IS COMPLETED

(71) Applicants: Judith H. Bank, Morrisville, NC (US); Erik S. Bryant, Wake Forest, NC (US); Gary Denner, Longwood (IE); Patrick J. O'Sullivan, Ballsbridge (IE)

(72) Inventors: Judith H. Bank, Morrisville, NC (US); Erik S. Bryant, Wake Forest, NC (US); Gary Denner, Longwood (IE); Patrick J. O'Sullivan, Ballsbridge (IE)

(73) Assignee: INTERNATIONAL BUSINESS MACHINES CORPORATION, Armonk, NY (US)

(21) Appl. No.: 13/473,718

(22) Filed: May 17, 2012

(51) Int. Cl. G06F 9/00; G06F 15/177

(52) U.S. Cl. 713/2

(57) ABSTRACT

A method, system and computer program product for providing a user access to specific programs and documents before a booting process is completed. A quick start list is generated containing a list of programs and documents that are to be provided priority in initialization during the booting process. A post-quick start list is generated that includes programs that are to be started after the initialization of the programs and documents listed in the quick start list. The programs and documents listed in the quick start list are initialized as soon as feasibly possible in light of the requirements of the booting process. Upon initializing these programs and documents, such programs and documents may be displayed as icons on the user's computer screen. As a result, the user has access to such programs and documents more quickly without having to wait for the booting process to be completed.

### TECHNICAL FIELD

The present invention relates generally to a computing device's startup process, and more particularly to providing the user access to specific programs and documents before the booting process is completed.

### BACKGROUND

In computing, booting is the initial set of operations that a computer system performs when the electrical power is switched on. The process begins when a computer that has been turned off is re-energized and ends when the computer is ready to perform its normal operations. The booting process may involve performing power-on self-test, locating and initializing peripheral devices, and finding, loading and starting the boot program, which typically is the operating system.

After giving control to the operating system, the operating system's startup process involves initializing software, device drivers and services. At times, especially in an enterprise environment (e.g., company, government agency), there are large number of programs and complicated security packages that are required for the workers' daily productivity and to comply with the organization's standards. Many of these programs and complicated security packages are initialized during the operating system's startup process. As a result, the booting process may take several minutes.

There are situations though when the user of the computer system needs to have access to specific programs or documents immediately without having to wait for the booting process to be completed. For example, suppose a person has an early morning teleconference meeting but cannot arrive in time to prepare for the meeting because he/she has to drop off his/her child for school. The person needs to call the conference phone number immediately upon arrival at work. However, the person cannot access the meeting invitation which contains the conference phone number until the booting process is completed. After the booting process is completed, the person launches the calendar application to obtain the meeting invitation so as to obtain the conference phone number. As a result, the person may waste many minutes (e.g., 5 to 10 minutes) before being able to access the meeting invitation so as to obtain the correct conference phone number.

### BRIEF SUMMARY

In one embodiment of the present invention, a method for providing a user access to specific programs and documents before a booting process of a computing device is completed comprises generating a first list of one or more programs and documents to be provided priority in initialization during the booting process of the computing device. The method further comprises generating a second list containing a list of programs other than the one or more programs listed in the first list that are to be started during the booting process of the computing device after the one or more programs and documents listed in the first list are initialized. Additionally, the method comprises initializing the one or more programs and documents listed in the first list before the booting process of the computing device is completed in response to the first list not being expired. In addition, the method comprises displaying, by a processor, the initialized one or more programs and documents as icons on a display of the computing device.

Other forms of the embodiment of the method described above are in a system and in a computer program product.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE SEVERAL VIEWS OF THE DRAWINGS

A better understanding of the present invention can be obtained when the following detailed description is considered in conjunction with the following drawings, in which:

FIG. 1 illustrates a network system configured in accordance with an embodiment of the present invention;

FIG. 2 illustrates a hardware configuration of a client device in accordance with an embodiment of the present invention;

FIG. 3 is a flowchart of a method for generating a quick start list containing a list of programs and documents that are to be provided priority in initialization during the booting process and a post-quick start list containing a list of programs that are to be started after the initialization of the programs and documents listed in the quick start list in accordance with an embodiment of the present invention; and

FIGS. 4A-4C are a flowchart of a method for providing a user access to specific programs and documents without having to wait for the booting process to be completed in accordance with an embodiment of the present invention.

### DETAILED DESCRIPTION

The present invention comprises a method, system and computer program product for providing a user access to specific programs and documents before a booting process of a computing device is completed. In one embodiment of the present invention, a list, referred to herein as the “quick start list,” is generated containing a list of programs and documents that are to be provided priority in initialization during the booting process of the computing device. The programs and documents listed in the quick start list may be manually selected by the user or automatically selected in light of the user's policy. Another list, referred to herein as the “post-quick start list,” is generated that includes the other programs that are to be started at boot time, where such programs are to be started after the initialization of the programs and documents listed in the quick start list. The programs and documents listed in the quick start list are initialized as soon as feasibly possible in light of the requirements of the booting process. For example, the programs and documents may be initialized as soon as feasibly possible during the operating system's startup process. Upon initializing these programs and documents, such programs and documents may be displayed as icons on the user's computer screen. By initializing and displaying the programs and documents listed in the quick start list prior to the conclusion of the booting process, the user has access to such programs and documents more quickly without having to wait for the booting process to be completed.

In the following description, numerous specific details are set forth to provide a thorough understanding of the present invention. However, it will be apparent to those skilled in the art that the present invention may be practiced without such specific details. In other instances, well-known circuits have been shown in block diagram form in order not to obscure the present invention in unnecessary detail. For the most part, details considering timing considerations and the like have been omitted inasmuch as such details are not necessary to obtain a complete understanding of the present invention and are within the skills of persons of ordinary skill in the relevant art.

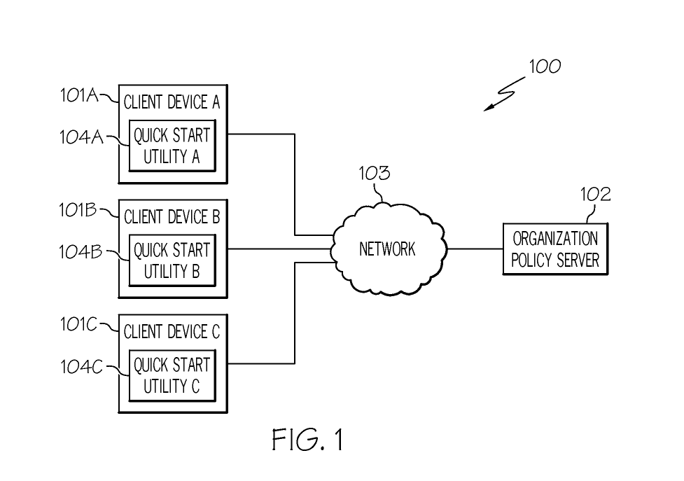

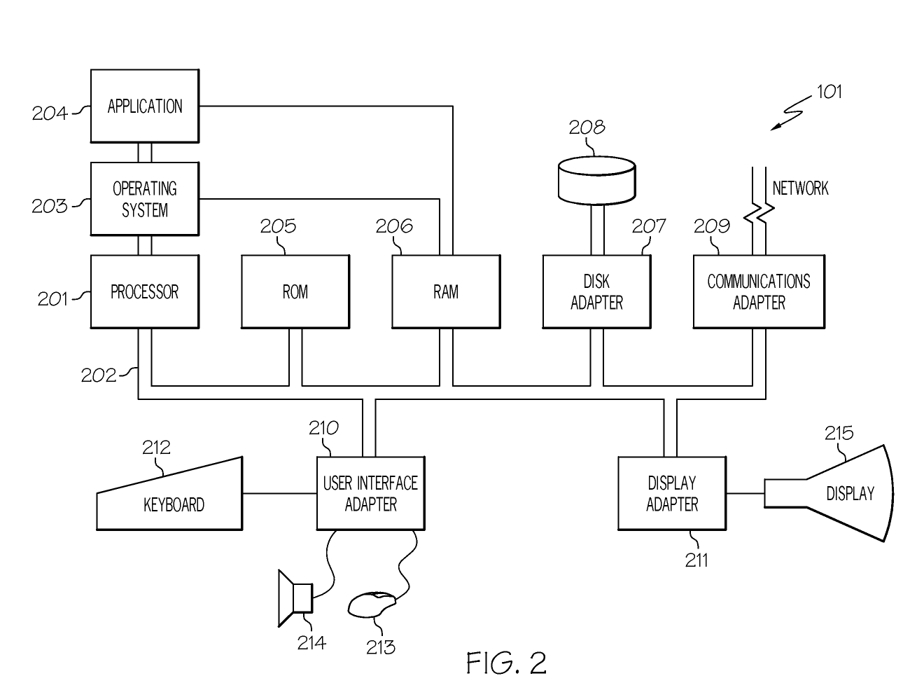

Referring now to the Figures in detail, FIG. 1 illustrates a network system 100 for practicing the principles of the present invention in accordance with an embodiment of the present invention. Network system 100 includes client devices 101A-101C (identified as “Client Device A,” “Client Device B,” and “Client Device C,” respectively, in FIG. 1) connected to a server 102 via a network 103. Client devices 101A-101C may collectively or individually be referred to as clients 101 or client 101, respectively. Client 101 may be any type of computing device (e.g., portable computing unit, personal digital assistant (PDA), smartphone, laptop computer, mobile phone, navigation device, game console, desktop computer system, workstation, Internet appliance and the like) configured with the capability of connecting to network 103 and consequently communicating with other clients 101 and server 102. A description of the hardware configuration of client 101 is provided below in connection with FIG. 2.

Network 103 may be, for example, a local area network, a wide area network, a wireless wide area network, a circuit-switched telephone network, a Global System for Mobile Communications (GSM) network, Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present invention.

In one embodiment, server 102 may represent a server referred to herein as the “organization policy server” configured to maintain policies (e.g., automatically quick start all programs and documents related to meetings within one half hour of a specific arrival time at work) created by the user of client 101 determining which programs and documents are to be provided priority in initialization during the booting process as discussed further below. In this manner, the user of client 101 is provided access to specific programs and documents without having to wait for the booting process to be completed as discussed further below. Furthermore, organization policy server 102 is configured to provide notifications (such as messages from other users of clients 101) to client 101 to be displayed on a display of client 101 without having to wait for the booting process to be completed as discussed further below.

Furthermore, in one embodiment, clients 101A-101C include a software agent, referred to herein as the “quick start utility” 104A-104C, respectively. Quick start utilities 104A-104C may collectively or individually be referred to as quick start utilities 104 or quick start utility 104, respectively. Quick start utility 104 is configured to provide the user of client 101 access to specific programs and documents without having to wait for the booting process to be completed as discussed further below.

While FIG. 1 illustrates three clients 101A-101C and a single server 102, network system 100 may include any number of clients 101 and servers 102. The embodiments of network system 100 are not to be limited in scope to the depiction of FIG. 1.

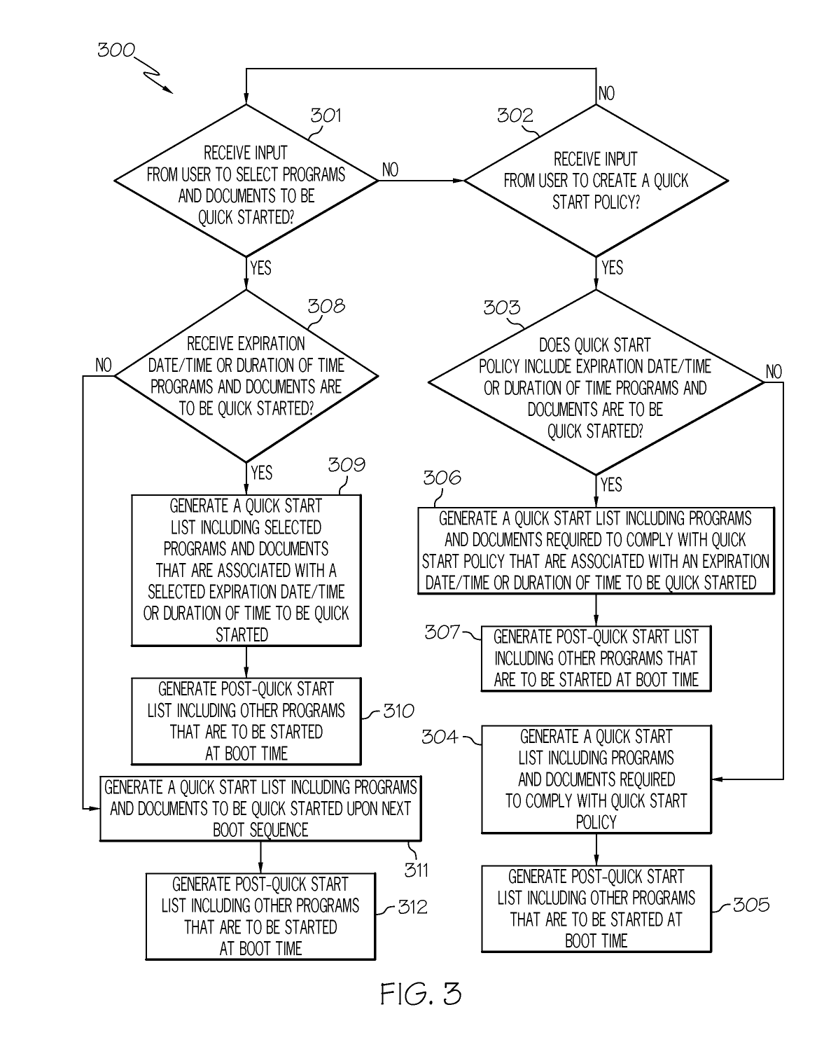

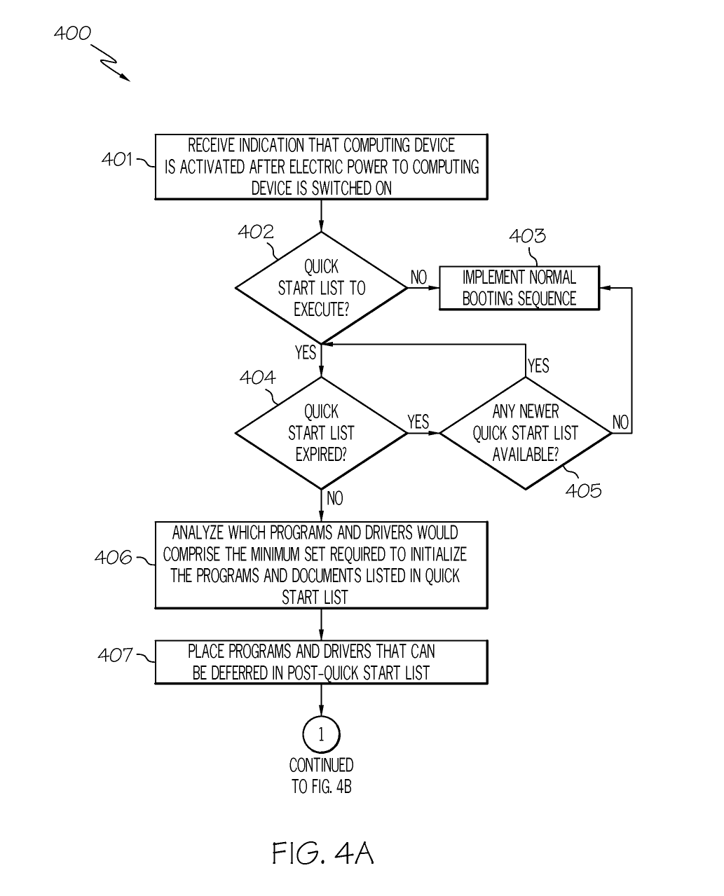

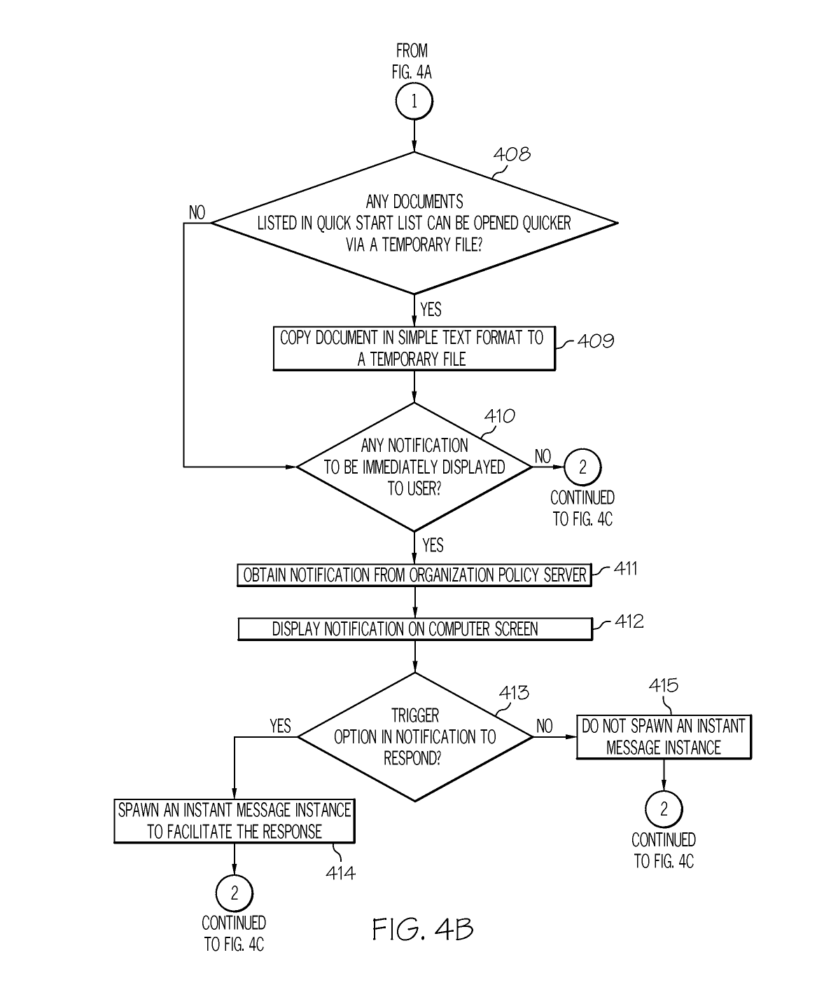

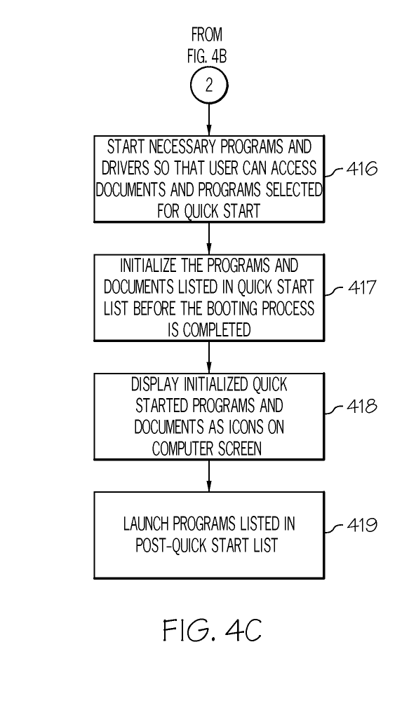

Referring now to FIG. 2, FIG. 2 illustrates a hardware configuration of client 101 (FIG. 1) which is representative of a hardware environment for practicing the present invention. Referring to FIG. 2, client 101 has a processor 201 coupled to various other components by system bus 202. An operating system 203 runs on processor 201 and provides control and coordinates the functions of the various components of FIG. 2. An application 204 in accordance with the principles of the present invention runs in conjunction with operating system 203 and provides calls to operating system 203 where the calls implement the various functions or services to be performed by application 204. Application 204 may include, for example, quick start utility 104 (FIG. 1) configured to provide the user of client 101 access to specific programs and documents without having to wait for the booting process to be completed as discussed further below in association with FIGS. 3 and 4A-4C.

Referring again to FIG. 2, read-only memory (“ROM”) 205 is coupled to system bus 202 and includes a basic input/output system (“BIOS”) that controls certain basic functions of client 101. Random access memory (“RAM”) 206 and disk adapter 207 are also coupled to system bus 202. It should be noted that software components including operating system 203 and application 204 may be loaded into RAM 206, which may be client's 101 main memory for execution. Disk adapter 207 may be an integrated drive electronics (“IDE”) adapter that communicates with a disk unit 208, e.g., disk drive. It is noted that the program for providing the user of client 101 access to specific programs and documents without having to wait for the booting process to be completed, as discussed further below in association with FIGS. 3 and 4A-4C, may reside in disk unit 208 or in application 204.

Client 101 may further include a communications adapter 209 coupled to bus 202. Communications adapter 209 interconnects bus 202 with an outside network (network 103 of FIG. 1) thereby enabling client 101 to communicate with other clients 101 and server 102.

I/O devices may also be connected to client 101 via a user interface adapter 210 and a display adapter 211. Keyboard 212, mouse 213 and speaker 214 may all be interconnected to bus 202 through user interface adapter 210. A display monitor 215 may be connected to system bus 202 by display adapter 211. In this manner, a user is capable of inputting to client 101 through keyboard 212 or mouse 213 and receiving output from client 101 via display 215 or speaker 214.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” ‘module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the C programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the function/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the function/acts specified in the flowchart and/or block diagram block or blocks.

As stated in the Background section, during the booting process, the operating system's startup process involves initializing software, device drivers and services. At times, especially in an enterprise environment (e.g., company, government agency), there are large number of programs and complicated security packages that are required for the workers' daily productivity and to comply with the organization's standards. Many of these programs and complicated security packages are initialized during the operating system's startup process. As a result, the booting process may take several minutes. There are situations though when the user of the computer system needs to have access to specific programs or documents immediately without having to wait for the booting process to be completed.

The principles of the present invention provide a means for accessing programs and documents without having to wait for the booting process to be completed as discussed further below in connection with FIGS. 3 and 4A-4C. FIG. 3 is a flowchart of a method for generating a quick start list containing a list of programs and documents that are to be provided priority in initialization during the booting process and a post-quick start list containing a list of programs that are to be started after the initialization of the programs and documents listed in the quick start list. FIGS. 4A-4C are a flowchart of a method for providing a user access to specific programs and documents without having to wait for the booting process to be completed.

As stated above, FIG. 3 is a flowchart of a method 300 for generating a quick start list containing a list of programs and documents that are to be provided priority in initialization during the booting process and a post-quick start list containing a list of programs that are to be started after the initialization of the programs and documents listed in the quick start list in accordance with an embodiment of the present invention.

Referring to FIG. 3, in conjunction with FIGS. 1-2, in step 301, a determination is made by quick start utility 104 as to whether it received input from the user of client 101 to select programs and documents to be “quick started.” “Quick started,” as used herein, refers to providing priority in initialization to programs and documents during the booting process, such as being initialized immediately upon activation of the operating system of client 101 before the other programs are started during the booting process, thereby providing the user access to these programs and documents before the booting process is completed. “Immediately,” as used herein, means as soon as feasibly possible in light of the requirements of the booting process.

If the user has not provided input to select particular programs and documents to be quick started, then, in step 302, a determination is made by quick start utility 104 as to whether it received input from the user of client 101 to create a “quick start policy.” A “quick start policy,” as used herein, refers to rules for establishing which programs and documents are to be provided priority in initialization during the booting process so that the user of client 101 is provided access to such programs and documents before the booting process is completed. For example, the user may create a quick start policy to automatically quick start all programs and documents related to meetings within one half hour of a specific arrival time at work. In such a policy, the programs and documents related to such a meeting (e.g., meeting invitation) would be almost immediately available to the user of client 101 once he/she logged onto client 101 as discussed further below. In one embodiment, the quick start policy may include an expiration date/time or duration of time that the programs and documents listed in the quick start list are to be quick started. A more detailed discussion of the use of the expiration date/time or duration of time is provided further below. In one embodiment, multiple quick start policies may exist. In one embodiment, such quick start policies may be stored in a storage unit (e.g., disk drive 208).

If the user has not provided input to create a quick start policy, then quick start utility 104 continues to determine whether it received input from the user of client 101 to select programs and documents to be quick started in step 301.

If, however, the user provided input to create a quick start policy, then, in step 303, a determination is made by quick start utility 104 as to whether the quick start policy includes an expiration date/time or duration of time that the programs and documents are to be quick started.

If the quick start policy does not include an expiration date/time or duration of time that the programs and documents are to be quick started, then, in step 304, quick start utility 104 generates a “quick start list” containing a list of programs and documents that are required to comply with the quick start policy. The programs and documents that are listed in the quick start list are to be provided priority in initialization during the booting process so as to be initialized before the booting process is completed, such as being almost immediately initialized after starting operating system 203 of client 101. Referring to the above example concerning the quick start policy, if the quick start policy is to automatically quick start all programs and documents related to meetings within one half hour of a specific arrival time at work, then the calendar application and the meeting invitation related to the meeting that is scheduled to start within one half hour of a specific arrival time at work would be listed in the quick start list to be quick started. By having a quick start list to indicate the programs and documents that are to be provided priority in initialization during the booting process, the user is now able to have access to such programs and documents before the booting process is completed. In one embodiment, the quick start list may be stored in a storage unit (e.g., disk drive 208).

In step 305, quick start utility 104 generates a “post-quick start list” that includes the other programs that are to be started at boot time. The “post-quick start list” refers to a list containing the programs that are to be started after the initialization of the programs and documents listed in the quick start list during the booting process. In one embodiment, the post-quick start list may be stored in a storage unit (e.g., disk drive 208).

Returning to step 303, if, however, the quick start policy includes an expiration date/time or duration of time that the programs and documents are to be quick started, then, in step 306, quick start utility 104 generates a “quick start list” containing a list of programs and documents that are required to comply with the quick start policy and are associated with the expiration date/time or duration of time to be quick started. In one embodiment, the quick start list may be stored in a storage unit (e.g., disk drive 208).

In step 307, quick start utility 104 generates a post-quick start list including the other programs that are to be started at boot time following the initialization of the programs and documents listed in the quick start list during the booting process. In one embodiment, the post-quick start list may be stored in a storage unit (e.g., disk drive 208).

Returning to step 301, if, however, the user provided input from the user of client 101 to select programs and documents to be “quick started,” then, in step 308, a determination is made by quick start utility 104 as to whether it received a duration of time or an expiration date/time that the programs and documents are to be quick started. For example, the user may manually select the programs and documents that are to be quick started the next day upon activation of client 101 and are to remain quick started for two hours after client 101 is activated. As a result, such programs and documents would be quick started if client 101 was restarted within two hours after the initial activation of client 101 the following day. In another example, the user may manually select the programs and documents that are to be quick started until a particular date/time (“expiration date/time”). For instance, the user may select a calendar application and a meeting invitation to be quick started until 9:00 AM the following day.

If the user provided a duration of time that the programs and documents are to be quick started, then, in step 309, quick start utility 104 generates a quick start list including the selected programs and documents that are associated with a selected expiration date/time or duration of time to be quick started. In one embodiment, the quick start list may be stored in a storage unit (e.g., disk drive 208).

In step 310, quick start utility 104 generates a post-quick start list including the other programs that are to be started at boot time following the initialization of the programs and documents listed in the quick start list during the booting process. In one embodiment, the post-quick start list may be stored in a storage unit (e.g., disk drive 208).

Returning to step 308, if, however, the user did not provide a duration of time or an expiration date/time that the programs and documents are to be quick started, then, in step 311, quick start utility 104 generates a “quick start list” containing a list of programs and documents that are to be quick started upon the next boot sequence. In one embodiment, the quick start list may be stored in a storage unit (e.g., disk drive 208).

In step 312, quick start utility 104 generates a post-quick start list including the other programs that are to be started at boot time following the initialization of the programs and documents listed in the quick start list during the booting process. In one embodiment, the post-quick start list may be stored in a storage unit (e.g., disk drive 208).

In some implementations, method 300 may include other and/or additional steps that, for clarity, are not depicted. Further, in some implementations, method 300 may be executed in a different order presented and that the order presented in the discussion of FIG. 3 is illustrative. Additionally, in some implementations, certain steps in method 300 may be executed in a substantially simultaneous manner or may be omitted.

Upon generating these quick start and post-quick start lists, the user will be provided access to specific programs and documents listed in the quick start list without having to wait for the booting process to be completed as discussed below in connection with FIGS. 4A-4C.

FIGS. 4A-4C are a flowchart of a method 400 for providing a user access to specific programs and documents without having to wait for the booting process to be completed in accordance with an embodiment of the present invention.

Referring to FIG. 4A, in conjunction with FIGS. 1-2, in step 401, quick start utility 104 receives an indication that client 101 is activated after the electric power to client 101 is switched on (i.e., receives an indication that control has been given to a boot program, such as operating system 203).

In step 402, a determination is made by quick start utility 104 as to whether there is a quick start list to execute. If there is not a quick start list to execute, then, in step 403, quick start utility 104 implements the normal booting sequence.

If, however, there is a quick start list to execute, then, in step 404, a determination is made by quick start utility 104 as to whether there is an expiration date/time associated with the quick start list, including a date/time that exceeds a duration of time that the programs and documents are to be quick started, and if so, if the quick start list is expired. As discussed above, the user's quick start policy may indicate an expiration date/time that the programs and documents listed in the quick start list are not to be quick started. Similarly, as discussed above, the user may manually enter an expiration date/time or duration of time in which the selected programs and documents listed in the quick start list are to be quick started.

If the quick start list is expired, then, in step 405, a determination is made by quick start utility 104 as to whether any newer quick start list is available. If a newer quick start list is available, then, in step 404, a determination is made by quick start utility 104 as to whether such a quick start list is associated with an expiration date/time, and if so, if the quick start list is expired.

If, however, there is no newer quick start list available, then quick start utility 104 implements the normal booting sequence in step 403.

Returning to step 404, if, however, the quick start list is not expired, then, in step 406, quick start utility 104 analyzes which programs and drivers would comprise the minimum set to initialize the programs and documents listed in the quick start list. For example, if networking applications were not immediately required during the booting process, such as when the meeting is to be conducted by phone, then starting such networking applications could be deferred. If, however, the meeting is a web conference meeting, then network applications would not be deferred. Other examples include collaboration programs, health checking applications and installation tools that may not be immediately required during the booting process and hence their initialization during the booting process can be deferred.

In step 407, quick start utility 104 places the programs and drivers that can be deferred, as discussed above in connection with step 406, in the post-quick start list.

Referring now to FIG. 4B, in conjunction with FIGS. 1-2, in step 408, a determination is made by quick start utility 104 as to whether any documents listed in the quick start list can be opened quicker via a temporary file. For example, a document, such as a calendar entry or e-mail, may be opened quicker by copying the document in a simple text format to a temporary file that can be opened by an application (e.g., Notepad, WordPad) that is quicker to initialize than the application that typically processes the document (e.g., calendar system application). In one embodiment, a historical record of how long it takes to initialize applications may be kept which would aid quick start utility 104 to determine which application to use. In one embodiment, such historical records may be periodically updated. In one embodiment, such historical records may be stored in a storage unit (e.g., disk drive 208).

If a document listed in the quick start list can be opened quicker via a temporary file, then, in step 409, quick start utility 104 copies the document in a simple text format to a temporary file as discussed above so that it can be opened quicker.

Upon executing step 409, or, if, however, there are no documents listed in the quick start list that can be opened quicker via a temporary file, then, in step 410, quick start utility 104 determines if there are any notifications to be immediately (as soon as feasibly possible in light of the requirements of the booting process) displayed to the user.

If there are notifications to be immediately displayed to the user, then, in step 411, quick start utility 104 obtains the notification from organization policy server 102. In one embodiment, other users of clients 101, such as peers in an organization, may desire to propagate a message to particular users in the organization. Such notifications may be provided to organization policy server 102 which in turn provides it to the requested end user. For example, a manger of a team may desire to propagate a message (e.g., “Please join me in meeting room G82 when you see this message”) to team members. In another example, a peer may desire to leave a notification (e.g., “Phone me when you get in please”) with another peer. In one embodiment, an administrator may configure organization policy server 102 to determine who can and cannot provide and receive such notifications.

In step 412, quick start utility 104 displays the retrieved notification from organization policy server 102 on display 215 of client 101. In one embodiment, the user may respond to the notification using a low-level messaging service (e.g., Windows® Messenger Service). Alternatively, the user may respond to the notification using a trigger option as discussed below.

In step 413, a determination is made by quick start utility 104 as to whether the user of client 101 that received the notification triggered an option in the notification to respond to the notification. In one embodiment, the notification provided by organization policy server 102 may be an instant message. Such a notification provided by organization policy sever 102 may also include metadata which includes information directed to the application that generated the instant message as well as the author of the notification. Upon the user triggering an option in the notification to respond to the notification, an instant message instance will be spawned to facilitate the response using the application that generated the instant message that was provided by the metadata.

If the user triggers the option in the notification to respond, then, in step 414, quick start utility 104 spawns an instance message instance to facilitate a response to the notification via the metadata provided with the notification as discussed above.

If, however, the user does not trigger the option in the notification to respond, then, in step 415, quick start utility 104 does not spawn an instant message instance.

Returning to step 410, if there are no notifications to be immediately displayed to the user or upon spawning an instant message instance in step 414 or upon not spawning an instant message instance in step 415, then, referring to FIG. 4C, in conjunction with FIGS. 1-2, in step 416, quick start utility 104 starts the necessary programs and drivers (such as the minimum set of programs and drivers that are required to initialize the programs and documents listed in the quick start list as determined in step 406) that are required to initialize the programs and drivers listed in the quick start list.

In step 417, quick start utility 104 initializes the programs and documents listed in quick start list before the booting process is completed (e.g., as soon as feasibly possible after activation of operating system 203 during operating system's 203 startup process).

In step 418, quick start utility 104 displays the initialized programs and documents as icons on display 215 of computing device 101 before the booting process is completed. In this manner, the user has access to particular programs and documents without having to wait for the booting process to be completed.

After initializing the programs and documents in the quick start list, in step 419, quick start utility 104 launches the programs listed in the post-quick start list.

In some implementations, method 400 may include other and/or additional steps that, for clarity, are not depicted. Further, in some implementations, method 400 may be executed in a different order presented and that the order presented in the discussion of FIGS. 4A-4C is illustrative. Additionally, in some implementations, certain steps in method 400 may be executed in a substantially simultaneous manner or may be omitted.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for providing a user access to specific programs and documents before a booting process of a computing device is completed, the method comprising:
generating a first list of one or more programs and documents to be provided priority in initialization during said booting process of said computing device;
generating a second list containing a list of programs other than said one or more programs listed in said first list that are to be started during said booting process of said computing device after said one or more programs and documents listed in said first list are initialized;
initializing said one or more programs and documents listed in said first list before said booting process of said computing device is completed in response to said first list not being expired; and
displaying, by a processor, said initialized one or more programs and documents as icons on a display of said computing device.

2. The method as recited in claim 1 further comprising:
receiving input from said user to select said one or more programs and documents to be listed in said first list.

3. The method as recited in claim 1 further comprising:
receiving an expiration time and date said one or more programs and documents listed in said first list are no longer to be provided priority in initialization during said booting process of said computing device.

4. The method as recited in claim 1 further comprising:
receiving input from said user to create a policy to automate a selection of said one or more programs and documents listed in said first list.

5. The method as recited in claim 4, wherein said one or more programs and documents listed in said first list comply with said policy.

6. The method as recited in claim 1 further comprising:
analyzing which programs and drivers form a minimum set required to initialize said one or more programs and documents listed in said first list; and
starting said minimum set of programs and drivers that are required to initialize said one or more programs and documents listed in said first list.

7. The method as recited in claim 6 further comprising:
listing programs and drivers that are not required to initialize said one or more programs and documents listed in said first list and can have its initialization deferred during said booting process of said computing device in said second list.

8. The method as recited in claim 1 further comprising:
identifying a third list of one or more programs and documents to be provided priority in initialization before said booting process of said computing device is completed in response to said first list being expired, wherein said third list is associated with a later expiration date than said first list.

9. The method as recited in claim 1 further comprising:
copying a document listed in said first list of one or more programs and documents in a simple text format to a temporary file.

10. The method as recited in claim 1 further comprising:
obtaining a notification from a server to be displayed on said display of said computing device before said booting process of said computing device is completed.

11. The method as recited in claim 10 further comprising:
spawning an instant message instance to facilitate a response to said notification in response to said user triggering an option in said notification to respond to said notification.

12. A computer program product embodied in a computer readable storage medium for providing a user access to specific programs and documents before a booting process of a computing device is completed, the computer program product comprising the programming instructions for:
generating a first list of one or more programs and documents to be provided priority in initialization during said booting process of said computing device;
generating a second list containing a list of programs other than said one or more programs listed in said first list that are to be started during said booting process of said computing device after said one or more programs and documents listed in said first list are initialized;
initializing said one or more programs and documents listed in said first list before said booting process of said computing device is completed in response to said first list not being expired; and
displaying said initialized one or more programs and documents as icons on a display of said computing device.

13. The computer program product as recited in claim 12 further comprising the programming instructions for:
receiving input from said user to select said one or more programs and documents to be listed in said first list.

14. The computer program product as recited in claim 12 further comprising the programming instructions for:
receiving an expiration time and date said one or more programs and documents listed in said first list are no longer to be provided priority in initialization during said booting process of said computing device.

15. The computer program product as recited in claim 12 further comprising the programming instructions for:
receiving input from said user to create a policy to automate a selection of said one or more programs and documents listed in said first list.

16. The computer program product as recited in claim 15, wherein said one or more programs and documents listed in said first list comply with said policy.

17. The computer program product as recited in claim 12 further comprising the programming instructions for:
analyzing which programs and drivers form a minimum set required to initialize said one or more programs and documents listed in said first list; and
starting said minimum set of programs and drivers that are required to initialize said one or more programs and documents listed in said first list.

18. The computer program product as recited in claim 12 further comprising the programming instructions for:
identifying a third list of one or more programs and documents to be provided priority in initialization before said booting process of said computing device is completed in response to said first list being expired, wherein said third list is associated with a later expiration date than said first list.

19. The computer program product as recited in claim 12 further comprising the programming instructions for:
obtaining a notification from a server to be displayed on said display of said computing device before said booting process of said computing device is completed.

20. A system, comprising:
a memory unit for storing a computer program for providing a user access to specific programs and documents before a booting process of said system is completed; and
a processor coupled to said memory unit, wherein said processor, responsive to said computer program, comprises:
circuitry for generating a first list of one or more programs and documents to be provided priority in initialization during said booting process of said system;
circuitry for generating a second list containing a list of programs other than said one or more programs listed in said first list that are to be started during said booting process of said system after said one or more programs and documents listed in said first list are initialized;
circuitry for initializing said one or more programs and documents listed in said first list before said booting process of said system is completed in response to said first list not being expired; and
circuitry for displaying said initialized one or more programs and documents as icons on a display of said system.
